(19) United States
(12) Patent Application Publication
(10) Pub. No.: US 2008/0143584 A1
(43) Pub. Date: Jun. 19, 2008

(54) Method and system for determining the distance between an RFID reader and an RFID tag using phase

(75) Inventors: Kambiz Shoarinejad, Los Angeles, CA (US); Maryam Soltan, Los Angeles, CA (US); Mehran Moshfeghi, Rancho Palos Verdes, CA (US)

Correspondence Address: FOUNTAINHEAD LAW GROUP, PC, 900 LAFAYETTE STREET, SUITE 509, SANTA CLARA, CA, 95050, US

(73) Assignee: Radiofy LLC, a California Limited Liability Company, Los Angeles, CA (US)

(21) Appl. No.: 11/641,623

(22) Filed: Dec. 18, 2006

(51) Int. Cl. G01S 13/08

(52) U.S. Cl. 342/127; 340/10.1

(57) ABSTRACT

Embodiments of the present invention include a method of determining a distance between an RFID reader and an RFID tag comprising transmitting two or more signals having two or more corresponding frequencies from said reader and measuring a phase difference between backscattered signals from said tag. A distance between the tag and reader may be determined using the measured phase difference. In one embodiment, multiple frequency pairs may be used and an average distance may be generated.

### BACKGROUND

The present invention relates to radio frequency identification (“RFID”), and in particular, to a method and system for determining the distance between an RFID reader and an RFID tag using phase.

RFID systems are useful in a wide variety of applications. RFID systems are radio communication systems that include small low cost electronic devices that store information including identification (“ID”) information, for example. These devices are referred to as RFID tags. The RFID tags may be designed using backscattering circuit techniques, for example, so that another device can retrieve the ID wirelessly. The retrieving device is typically referred to as a “reader,” and sometimes “an interrogator.” The tags are typically very small, and may be placed on a variety of items including equipment, products, or even people, for example, and identification of such items may be made through a reader. Accordingly, RFID systems may be used to track inventory in a warehouse, the number of products on store shelves, or the location of equipment in a company, to name just a few example applications.

RFID systems may include large numbers of tags and readers spread out across potentially wide areas. It is often desirable to obtain the location of items having attached tags. For example, in a factory, an RFID tag may be affixed to particular tools, and it may be desirable to locate a particular tool or tools using the attached RFID tag. To determine the location of a tag, it may be useful to measure the distance between the reader and the tag. However, determining an accurate distance between the reader and the tag can be difficult.

The present invention provides a method and system for determining the distance between an RFID reader and an RFID tag using phase.

### SUMMARY

Embodiments of the present invention include a method of determining a distance between an RFID reader and an RFID tag comprising transmitting two or more signals having two or more corresponding frequencies from said reader and measuring a phase difference between backscattered signals from said tag. A distance between the tag and reader may be determined using the measured phase difference. In one embodiment, multiple frequency pairs may be used. Average distances may be generated, for example.

These and other features of the present invention are detailed in the following drawings and related description.

### BRIEF DESCRIPTION OF THE DRAWINGS

FIG. 1 illustrates an RFID system according to one embodiment of the present invention.

FIG. 2 illustrates the use of multiple frequency signals to determine distance between an RFID reader and a tag according to one embodiment of the present invention.

FIG. 3 illustrates the relationship between the difference in frequency between two signals used to measure distance and the difference in phase.

FIG. 4 illustrates a method according to one embodiment of the present invention.

FIG. 5 illustrates a method according to another embodiment-of the present invention.

### DETAILED DESCRIPTION

Described herein are techniques for determining the distance between an RFID reader and an RFID tag. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

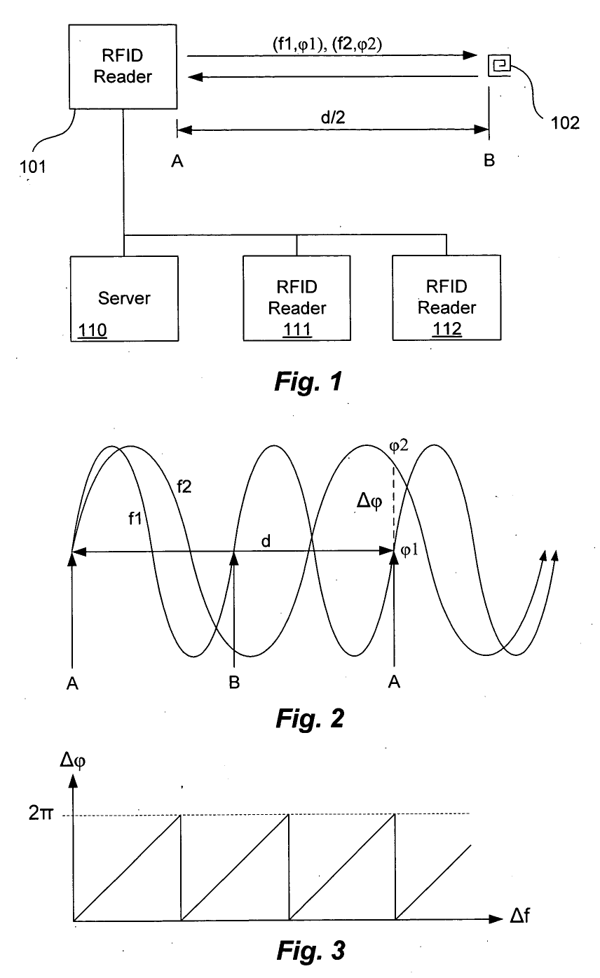

FIG. 1 illustrates an RFID system according to one embodiment of the present invention. An RFID reader 101 may include a backscattering transceiver for communicating with tag 102 using RFID backscattering techniques. A “backscattering transceiver” generally refers to a circuit that is capable of receiving or transmitting, or both, data using backscattering techniques. Example backscattering circuits and techniques that may be used in the present invention are disclosed in “RFID Handbook: Fundamentals and Applications in Contactless Smart Cards and Identification,” by Klaus Finkenzeller, John Wiley & Sons; 2 edition, May 23, 2003, (ISBN: 0470844027). More specifically, “backscattering” broadly refers to the process of transmitting data using an RF carrier wave between a reader and a tag wherein the tag may communicate with the reader using RF reflections from the tag's antenna. In some implementations, the tag may absorb and use at least some power (energy) from the RF signal transmitted by the reader. Transmission from the tag to the reader is typically accomplished by modulating the impedance of the tag's antenna so that the radar signature of the tag changes over time in a controlled manner. An RF signal from the reader is backscattered from the tag to the reader, and the reader senses the changes in the backscattered signal caused by the modulated impedance of the tag antenna. Accordingly, data encoded in the modulated antenna may be passed back to the reader. In a passive tag, the energy from the reader's transmitted signal may be absorbed and used to power the modulation and potentially other functionality. Accordingly, a backscattering system will typically include a reader backscattering circuit and a tag backscattering circuit.

Embodiments of the present invention may be used to determine the distance between a reader and a tag. Rather than sending out only one RF signal to communicate with the tag, reader 101, reader 101 transmits two (or more) RF signals having two (or more) corresponding frequencies. The signals including frequencies f1 and f2 propagate toward the tag and are reflected back to the reader. At any given point in space between the reader and the tag, the signal with frequency f1 will have a corresponding phase φ1, and the signal with frequency f2 will have a corresponding phase φ2. The two signals are illustrated as follows:

(f1,φ1), (f2,φ2)

Initially, at the reader transmitter, the difference in phase between the two signal frequencies will be zero. However, because two different frequencies are used, a phase difference, Δφ, will be accumulated as the signals propagate to and from the tag. This phenomenon is illustrated in FIG. 2, which illustrates multiple frequency signals. A first signal having a frequency f1 and a second signal having a frequency f2 are shown in FIG. 2. The signals with different frequencies, f, will have different corresponding wavelengths, λ, that can be determined as follows.

λ=c/f,

where c is the speed of light (i.e., 3×10⁸ m/s). As illustrated in FIG. 1, the transmitted signals will propagate between the RFID reader at location A, to the tag 102 located at B, and back to reader 101 at location A. The distance between the reader and tag is one-half (½) the round trip propagation distance d (i.e., d/2, the distance between A and B).

The round trip distance, d, is illustrated in FIG. 2. FIG. 2 illustrates that initially the two signals are in-phase (Δφ=0). The signals propagate from the reader at location A, to the tag at location B, and back to the reader at location A, thereby traversing a distance, d. When the signals arrive back at location A, there is an accumulated phase difference, Δφ, which can be measured and used to calculate the distance, d, as follows. If the signals are represented as sinusoids, a first signal transmitted by the RFID reader with a frequency f1 is represented as:

y1=A sin(w₁t+φₒ),

where w₁ is the frequency in radians and φₒ is the initial phase offset and may be zero. The backscattered signal returned from the tag and received at the RFID reader is represented as:

y2=B sin(w₁t+φₒ+φᵣ+φ₁),

where φᵣ is a change in phase due to tag reflection (not shown in FIG. 2 for illustrative purposes) and φ₁ is the total phase change across the distance, d, traveled. The phase of y2 is related to distance as follows:

φ₁=2πd/λ₁

where λ₁ is the wavelength of the signal with frequency f1.

Similarly, a second signal transmitted by the RFID reader with a frequency f2 is represented as:

y3=C sin(w₂t+φₒ),

where w₂ is the frequency in radians and φₒ is the initial phase offset and may be zero. The second backscattered signal returned from the tag and received at the RFID reader is represented as:

y4=D sin(w₂t+φₒ+φᵣ+φ₂),

where φᵣ is a change in phase due to tag reflection, which is assumed the same for both signals at frequencies f1 and f2, and φ₂ is the total phase change across the distance, d, traveled for the second signal. The phase of y4 is related to distance as follows:

φ₂=2πd/λ₂

where λ₂ is the wavelength of the signal with frequency f2.

For both signals, the distance, d, may be represented as an integer number of full wavelengths and a fractional (or residual) wavelength. For example, φ₁ and φ₂ may be represented as follows:

$$\begin{matrix}{ϕ}_{1} = 2 π d / {λ}_{1} \\ = \frac{2 π}{{λ}_{1}} ( {N}_{1} {λ}_{1} + \frac{ {\overline{φ}}_{1}}{2 π} {λ}_{1} ) \\ = 2 π {N}_{1} + {\overline{φ}}_{1}\end{matrix}$$

$$\begin{matrix}{ϕ}_{2} = 2 π d / {λ}_{2} \\ = \frac{2 π}{{λ}_{2}} ( {N}_{2} {λ}_{2} + \frac{ {\overline{φ}}_{2}}{2 π} {λ}_{2} ) \\ = 2 π {N}_{2} + {\overline{φ}}_{2}\end{matrix}$$

where λ₁ and λ₂ are the wavelengths of f1 and f2, N₁ and N₂ are integer number of full cycles of f1 and f2, and φ̅₁ and φ̅₂ are the residual non-integer phases of the signals f1 and f2 across the round-trip distance, d. Accordingly, the total phase difference at the RFID readers is as follows:

$$\begin{matrix}Δ φ = {φ}_{1} - {φ}_{2} \\ = \frac{2 π d}{{λ}_{1}} - \frac{2 π d}{{λ}_{2}} \\ = 2 π ( {N}_{1} - {N}_{2} ) + {\overline{φ}}_{1} - {\overline{φ}}_{2} .\end{matrix}$$

FIG. 3 illustrates the relationship between the difference in frequency between two signals used to measure distance and the difference in phase. This figure illustrates that the phase difference will accumulate up to 2π, and then begins increasing again from zero. However, assuming the number of full cycles stays the same for both frequencies, then

$${N}_{1} = {N}_{2} , \\ Δ {φ}_{m} = \overline{{φ}_{1}} - \overline{{φ}_{2}} = 2 π d ( \frac{1}{{λ}_{1}} - \frac{1}{{λ}_{2}} ) , and$$

$$d = \frac{Δ {φ}_{m}}{2 π} ( \frac{1}{\frac{1}{{λ}_{1}} - \frac{1}{{λ}_{2}}} ) = \frac{c Δ {φ}_{m}}{2 π ( {f}_{1} - {f}_{2} )} ,$$

wherein Δφₘ is the residual phase difference of the backscattered signals that may be received and measured by the RFID reader, c is the speed of light, and f1 and f2 are the frequencies of the signals. Therefore, using the measured phase difference, Δφₘ, a distance, d, may be determined, which is the round trip distance between the RFID reader and tag to be located. From d, the distance between the RFID reader and the tag may be found as d1=d/2.

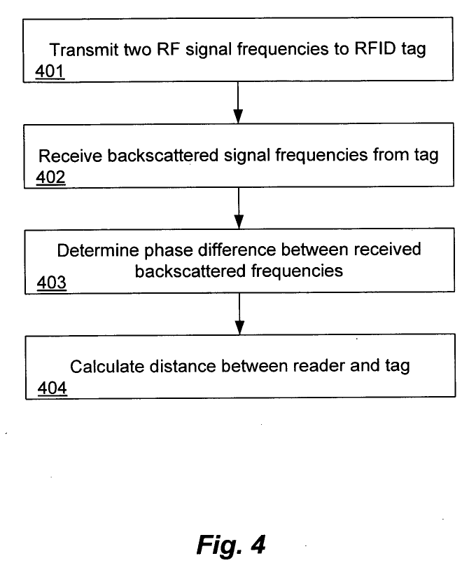

FIG. 4 illustrates a method according to one embodiment of the present invention. At 401, two RF signal frequencies are transmitted from an RFID reader to an RFID tag. It is to be understood that the two signal frequencies may be transmitted at the same time (e.g., as a multitone signal) or the two signal frequencies may be transmitted at different times (e.g., sequentially). At 402, the backscattered signal frequencies are received from the tag. At 403, the phase difference between the received backscattered frequencies is determined. At 404, the distance between the reader and tag is calculated using the measured phase difference.

From the above equations, it can be seen that the distance is proportional to the change in phase over the change in frequency. This is illustrated as the slope of the waveform in FIG. 3. Accordingly, distance can be obtained by curve fitting multiple measurements across changes in phase and frequency. By obtaining a plurality of measurements at different frequency differences and different phase differences, the distance can be determined by the slope of a line fit to the measured data, for example.

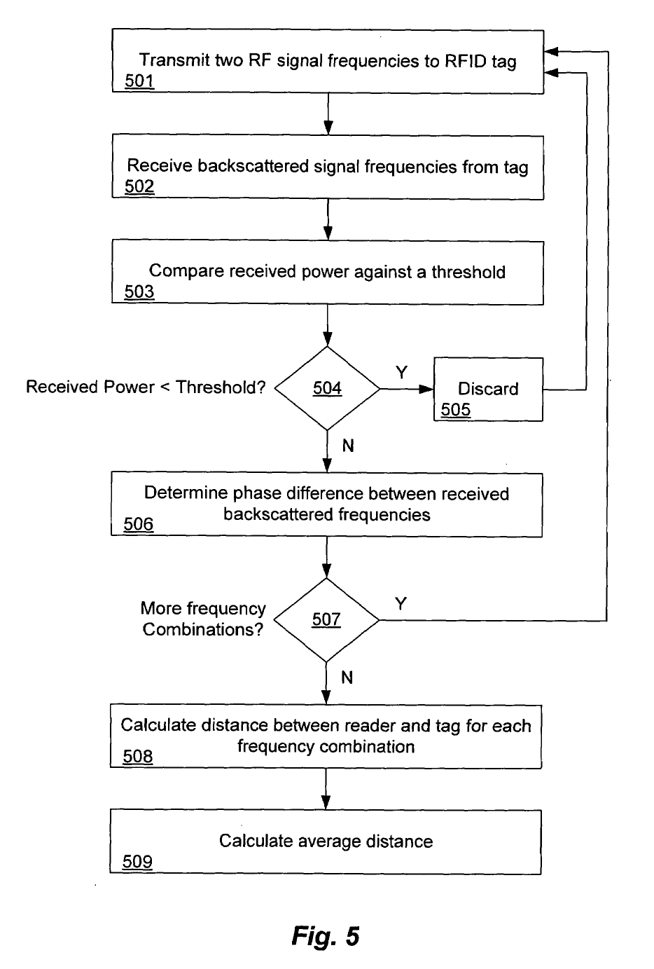

FIG. 5 illustrates a method according to another embodiment of the present invention. At 501, two RF signal frequencies are transmitted from an RFID reader to an RFID tag, and at 502, the backscattered signal frequencies are received from the tag. In this example, the received power is monitored and used to eliminate spurious data. At 503, the received power is compared against a threshold. At 504, if the received power is less than the threshold, the incoming signal is discarded, and the process returns to 501. Low power signals may correspond to reflections rather than the desired return signal from the RFID tag. At 506, the phase difference between the received backscattered frequencies is determined. At 507, additional frequency combinations may be used. For example, the same frequency difference may be used, but with different first and second signal frequencies (e.g., Δf=(900 MHz, 901 Hz), (901 MHz, 902 MHz), . . . (929 MHz, 930 MHz)). The distance between the reader and tag may be calculated for each pair of frequencies, and an average calculated distance obtained. As another example, the frequency difference may be changed. For example, Δf1 may be 1 MHz, Δf2 may be 2 MHz, or Δf3 may be 3 MHz. Alternatively, one frequency is held constant and the second RF signal is varied across a range of frequencies to produce a range of frequency differences (e.g., (f1, f2)=(900 MHz, 901 MHz), (900 MHz, 902 MHz), (900 MHz, 903 MHz), . . . ). These techniques may be combined where one frequency difference is used across a range of frequencies as above, and then other frequency differences are used across ranges of frequencies (e.g., Δf2=(900 MHz, 902 MHz), (902 MHz, 904 MHz), . . . (928 MHz, 930 MHz)). At 507, if more frequency combinations are being used, the process returns to 501. At 508, the distance between the reader and tag may be calculated for each frequency combination. At 509, the average distance or other statistical calculations may be performed using the measured data.

In some embodiments, directional antennas may be used to improve results. For example, the antenna may first be calibrated to obtain maximum power. When the maximum power configuration is obtained, the measurement may be taken.

Referring again to FIG. 1, reader 101 may be coupled to an external system, such as a server 110. The server may be a central processing element of a network of readers, for example. Server 110 may be coupled to a network of RFID readers including readers 101, 111, and 112. Using the techniques described herein, the readers and server may be used to perform further tag location using techniques described in commonly-owned concurrently filed U.S. patent application Ser. No. ______(Attorney Docket No. 000019-000500US), filed on Dec. 18, 2006, entitled “RFID Location Systems and Methods,” naming Kambiz Shoarinejad, Maryam Soltan, and Mehran Moshfeghi and as inventors, the entire disclosure of which is hereby incorporated herein by reference.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A method of determining a distance between an RFID reader and an RFID tag comprising:
transmitting two or more RF signals having corresponding two or more frequencies from said reader, and in accordance therewith, receiving two or more backscattered signals having the two or more frequencies in the one or more readers from said tag;
measuring a phase difference between the two or more frequencies of the backscattered signals; and
determining said distance between said reader and said tag using the measured phase difference.

2. The method of claim 1 wherein the two or more RF signals are transmitted at the same time.

3. The method of claim 1 wherein the two or more RF signals are transmitted at different times.

4. The method of claim 1 wherein said transmitting two or more RF signals comprises transmitting a plurality of first and second RF signal pairs, and said measuring a phase difference comprises measuring a plurality of phase differences.

5. The method of claim 4 wherein said determining a distance comprises determining a plurality of distances and generating an average distance.

6. The method of claim 4 wherein the frequency difference between each of the first and second RF signal pairs is the constant.

7. The method of claim 4 wherein the first RF signal in each RF signal pair has the same frequency and the frequency of the second RF signals in the RF signal pairs is varied across a range of frequencies.

8. The method of claim 1 further comprising detecting the power of at least one of the two or more backscattered signals, and comparing the detected power against a threshold.

9. The method of claim 1 further comprising transmitting the phase difference to an external system, wherein said determining is performed on the external system.

10. The method of claim 9 wherein the external system is a server coupled to one or more RFID readers.

11. The method of claim 9 wherein the external system receives phase difference information from a plurality of RFID readers.

12. A method of determining a distance between an RFID reader and an RFID tag comprising transmitting two or more signals having two or more corresponding frequencies from said reader and measuring a phase difference between backscattered signals from said tag.

13. The method of claim 12 wherein the two or more RF signals are transmitted at the same time.

14. The method of claim 12 wherein the two or more RF signals are transmitted at different times.

15. The method of claim 12 further comprising determining said distance between the reader and the tag using the measured phase difference.

16. The method of claim 12 wherein said transmitting two or more RF signals comprises transmitting a plurality of first and second RF signal pairs, and said measuring a phase difference comprises measuring a plurality of phase differences.

17. The method of claim 16 further comprising determining a plurality of distances and generating an average distance.

18. The method of claim 16 wherein the frequency difference between each of the first and second RF signal pairs is the constant.

19. The method of claim 16 further comprising detecting the power of a backscattered signal, and comparing the detected power against a threshold.

20. The method of claim 12 further comprising transmitting the phase difference to an external system, and determining said distance on the external system using the phase difference.

21. A RFID system comprising:
an RFID tag;
an RFID reader;
wherein the reader transmits two or more signals having two or more corresponding frequencies and measures a phase difference between backscattered signals from the tag.
